(19) United States
(12) Patent Application Publication
(10) Pub. No.: US 2016/0307218 A1
(43) Pub. Date: Oct. 20, 2016

(54) SYSTEM AND METHOD FOR PHASED ESTIMATION AND CORRECTION OF PROMOTION EFFECTS

(71) Applicant: ORACLE INTERNATIONAL CORPORATION, Redwood Shores, CA (US)

(72) Inventors: Ming LEI, Lutherville-Timonium, MD (US); Catalin POPESCU, Atlanta, GA (US)

(21) Appl. No.: 14/686,896

(22) Filed: Apr. 15, 2015

(51) Int. Cl. G06Q 30/02

(52) U.S. Cl. CPC G06Q 30/0202; G06Q 30/0211; G06Q 30/0242

(57) ABSTRACT

Systems, methods, and other embodiments are disclosed that are configured to generate promotion effects for use by a demand forecast model. In one embodiment, a first regression analysis is performed on historical performance data for an item to generate first promotion effect values for a plurality of promotion components. The first promotion effect values are compared to a plurality of rules. If none of the rules are violated by the first promotion effect values, the first promotion effect values are output as final promotion effect values. If at least one of the rules is violated by the first promotion effect values, a phased operation is performed on the historical performance data. The phased operation operates on subsets of the promotion components of the historical performance data over at least two regression analysis phases to generate second promotion effect values.

### BACKGROUND

A retail business needs to manage its supply chain of products. In one aspect, computer applications are used to manage inventory of products and determine demand forecasts based on promotions. Forecasting demand is a big part of managing a retail business and is a key driver of the supply chain. In retail, when a product is promoted, the sales of the promoted product will usually increase.

Retailers often use promotions to boost sales of items. There are many ways to promote a product (e.g., commercials, price discounts, buy two items and get one item free, etc.). The price discount is used very often as a promotion tool and tends to be very effective. However, retailers often use a combination of promotions to boost sales of an item.

Retailers use sales and promotion history to predict the effects of each type of promotion. Predicting the effects of a promotion can be difficult considering the different ways a promotion can be modeled. Furthermore, when a combination of promotion types is employed for an item over a similar period of time, predicting the effects of the various promotion types can be very difficult.

In general, customers pay special attention to promoted items. If a promotion is poorly planned, and the forecast is too high, items will remain unsold. The items will need to be sold at a discount or discarded as waste, decreasing profitability. If the forecast is low, demand is not satisfied and retailers experience lost sales and low client satisfaction which have a negative impact on revenue.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with a promotion effects tool;

FIG. 2 illustrates one embodiment of a method, which can be performed by the promotion effects tool of the computer system of FIG. 1, for generating promotion effect values;

FIG. 3A illustrates an embodiment of a portion of a table of historical performance data of an item that includes unit sales and data associated with a plurality of promotion components;

FIG. 3B illustrates an embodiment of a table of first promotion effect values derived from the historical performance data of FIG. 3A;

FIG. 4A illustrates an embodiment of a table of promotion discount data extracted from the historical performance data of FIG. 3A;

FIG. 4B illustrates an embodiment of a table of de-priced performance data derived from the historical performance data of FIG. 3A and the promotion discount data of FIG. 4A;

FIG. 5 illustrates an embodiment of a table of second promotion effect values derived from the promotion discount data of FIG. 4A and the de-priced performance data of FIG. 4B; and

FIG. 6 illustrates one embodiment of a computing device upon which a promotion effects tool of a computing system may be implemented.

### DETAILED DESCRIPTION

Systems, methods, and other embodiments are disclosed for generating values representing promotion effects for merchandise items. Example embodiments are discussed herein with respect to a computerized system that implements demand forecasting and management of retail data, where sales histories and promotion histories of retail items are taken into consideration.

In one embodiment, a promotion effects tool is disclosed that is configured to generate promotion effect values for an item based on the sales and promotion histories (historical performance data). The promotion effects tool is also configured to take into account whether or not certain defined business rules are violated by any of the generated promotion effect values. When a business rule is violated, a phased approach is taken to re-estimate the promotion effect values in an attempt to mitigate any unstable behavior or inaccurate results. The present systems and methods improve a computer system to more accurately characterize the effects of various types of promotions for retail items to aid in demand forecasting.

The following terms are used herein with respect to various embodiments.

The term “item” or “retail item”, as used herein, refers to merchandise sold, purchased, and/or returned in a sales environment.

The terms “period”, “time period”, “retail period”, or “calendar period”, as used herein, refer to a unit increment of time (e.g., a 7-day week) which sellers use to correlate seasonal periods from one year to the next in a calendar for the purposes of planning and forecasting. The terms may be used interchangeably herein.

The term “location” or “retail location”, as used herein, may refer to a physical store where an item is sold, or to an on-line store via which an item is sold.

The term “historical performance data”, as used herein, refers to sales and promotion information that has been recorded for an item that has been sold in past retail periods (e.g., over 52 weeks of the past year). Historical performance data may include, for example, a number of units of an item sold in each retail period along with data characterizing one or more types of promotions for the item. Historical performance data may be stored in a database device, for example.

The term “promotion component”, as used herein, refers to a particular type of promotion for an item. Some examples of promotion components may include a price discount promotion component, a television advertisement component, a radio advertisement component, a newspaper advertisement component, an internet advertisement component, an email advertisement component, and an in-store advertisement component.

The term “promotion effect value”, as used herein, refers to a numerical value that characterizes the effect of a promotion component of an item. For example, a price elasticity value of 6.917 may be a promotion effect value that characterizes a price discount promotion component of an item. Promotion effect values may be used in a demand forecast model to forecast a demand for an item.

The term “regression analysis phase”, as used herein, refers to a regression analysis that is preceded by and/or followed by another regression analysis during a phased operation.

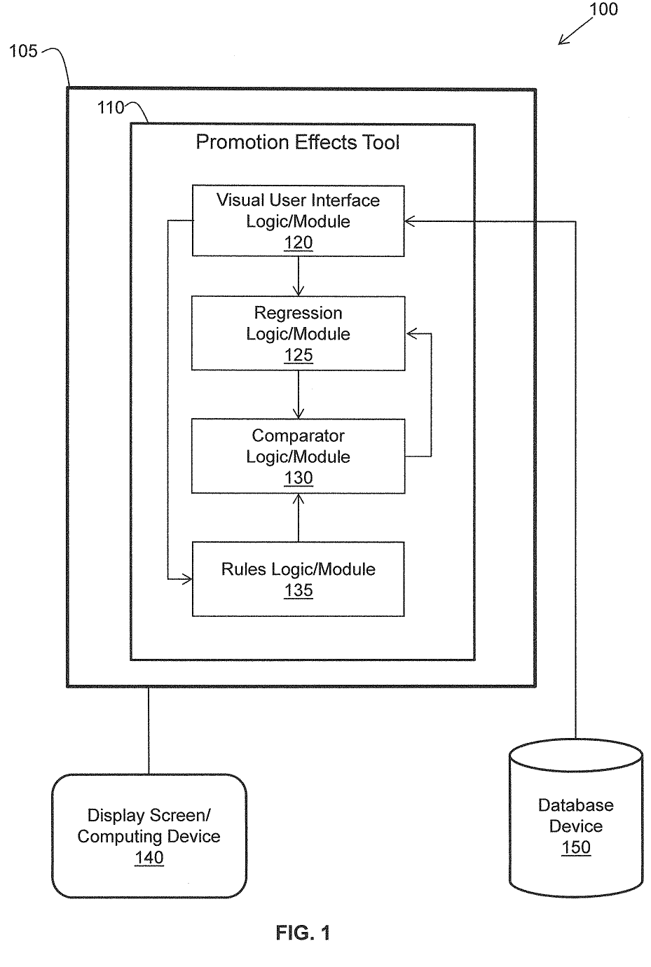

FIG. 1 illustrates one embodiment of a computer system 100, having a computing device 105 configured with a promotion effects tool 110. For example, in one embodiment, the promotion effects tool 110 may be part of a larger computer application, configured to forecast and manage sales, promotions, and inventory for retail items at various retail locations. The promotion effects tool 110 is configured to computerize the process for analyzing sales and promotion data (historical performance data) to generate promotion effect values that may be used by a demand model to forecast demand for items.

In one embodiment, the system 100 is a computing/data processing system including an application or collection of distributed applications for enterprise organizations. The applications and computing system 100 may be configured to operate with or be implemented as a cloud-based networking system, a software-as-a-service (SaaS) architecture, or other type of computing solution.

The embodiments described herein allow estimation of promotion effects jointly and in a staged (phased) manner. Estimation logic determines which approach yields a more accurate demand forecast and maintains a high degree of reliability. Different types of promotions may be grouped into different phases, based on business needs, when determining the promotion effects.

In one embodiment, a computer algorithm is disclosed that implements an analytical approach to determining promotion effect values for an item. It is assumed herein that historical performance data is available for use and that a demand model is defined which can be used for performing regression analyses on the historical performance data.

The forecast is an important driver of the supply chain. If a forecast is inaccurate, allocation and replenishment perform poorly, resulting in financial loss for the retailer. Improvements in forecast accuracy for promoted items may be achieved by the embodiments disclosed herein. Furthermore, a better understanding of the impact a promotion has on demand may be achieved. This helps the retailer to more effectively plan promotions with respect to channel, pricing, and customer segments, for example.

With reference to FIG. 1, in one embodiment, the promotion effects tool 110 is implemented on the computing device 105 and includes logics for implementing various functional aspects of the promotion effects tool 110. In one embodiment, the promotion effects tool 110 includes visual user interface logic 120, regression logic 125, comparator logic 130, and rules logic 135.

The computer system 100 also includes a display screen 140 operably connected to the computing device 105. In accordance with one embodiment, the display screen 140 is implemented to display views of and facilitate user interaction with a graphical user interface (GUI) generated by the visual user interface logic 120 for viewing and updating information associated with promotion components. The graphical user interface may be associated with a promotion effects application and the visual user interface logic 120 may be configured to generate the graphical user interface.

In one embodiment, the computer system 100 is a centralized server-side application that provides at least the functions disclosed herein and that is accessed by many users via computing devices/terminals communicating with the computer system 100 (functioning as the server) over a computer network. Thus the display screen 140 may represent multiple computing devices/terminals that allow users to access and receive services from the promotion effects tool 110 via networked computer communications.

In one embodiment, the computer system 100 further includes at least one database device 150 operably connected to the computing device 105 and/or a network interface to access the database device 150 via a network connection. For example, in one embodiment, the database device 150 is operably connected to the visual user interface logic 120. In accordance with one embodiment, the database device 150 is configured to store and manage data structures (e.g., records of historical performance data) associated with the promotion effects tool 110 in a database system (e.g., a computerized inventory management and demand forecasting application).

Other embodiments may provide different logics or combinations of logics that provide the same or similar functionality as the promotion effects tool 110 of FIG. 1. In one embodiment, the promotion effects tool 110 is an executable application including algorithms and/or program modules configured to perform the functions of the logics. The application is stored in a non-transitory computer storage medium. That is, in one embodiment, the logics of the tool 110 are implemented as modules of instructions stored on a computer-readable medium.

Referring back to the logics of the promotion effects tool 110 of FIG. 1, in one embodiment, the visual user interface logic 120 is configured to generate a graphical user interface (GUI) to facilitate user interaction with the promotion effects tool 110. For example, the visual user interface logic 120 includes program code that generates and causes the graphical user interface to be displayed based on an implemented graphical design of the interface. In response to user actions and selections via the GUI, associated aspects of generating promotion effect values for retail items may be manipulated.

For example, in one embodiment, the visual user interface logic 120 is configured to facilitate receiving inputs and reading data in response to user actions. For example, the visual user interface logic 120 may facilitate selection, reading, and inputting of historical performance data associated with retail items sold at retail locations. The historical performance data may reside in at least one data structure (e.g., within database device 150) associated with (and accessible by) a promotion effects application (e.g., the promotion effects tool 110) via the graphical user interface. The generation of promotion effect values may be based at least in part on the historical performance data.

Historical performance data may include, for example, data representing past sales and promotions of an item across a plurality of past retail periods. The historical performance data may be segmented into retail periods of past weeks, with each past week having numerical values assigned to it to indicate the number of items sold for that week. The historical performance data may also include numerical values representing price discounts and values of other promotion components across the retail periods, in accordance with one embodiment. The historical performance data for an item may be accessed via network communications, in accordance with one embodiment.

Furthermore, the visual user interface logic 120 is configured to facilitate the outputting and displaying of promotion effect values, via the graphical user interface, on the display screen 140. Promotion effect values may include, for example, a price elasticity value for an item as well as other numerical values characterizing the effects of other promotion components associated with the item. For example, a price elasticity value represents a measure of how a demand for an item responds to a change in a price of the item.

In one embodiment, regression logic 125 is configured to operably interact with the visual user interface logic 120 to facilitate displaying of promotion effect values of an output data structure, as discussed later herein. Furthermore, in one embodiment, rules logic 135 is configured to operably interact with the visual user interface logic 120 to facilitate generating a set of rules (e.g., business rules) to which corresponding promotion effect values may be compared, as discussed later herein.

Referring again to FIG. 1, in one embodiment, the regression logic 125 is configured to perform a regression analysis on historical performance data for an item where the regression analysis is based on a forecast demand model. The regression analysis results in the generation of promotion effect values for a plurality of promotion components associated with the item.

The historical performance data includes sales data associated with the plurality of promotion components across a plurality of time periods (e.g., weeks). Examples of promotion components include, but are not limited to, a price discount component, a television advertisement component, a radio advertisement component, a newspaper advertisement component, an email advertisement component, an internet advertisement component, and an in-store advertisement component.

The regression logic 125 is also configured to perform, under certain circumstances, a phased operation on the historical performance data. The phased operation is performed on subsets of the plurality of promotion components of the historical performance data over two or more regression analysis phases to generate promotion effect values.

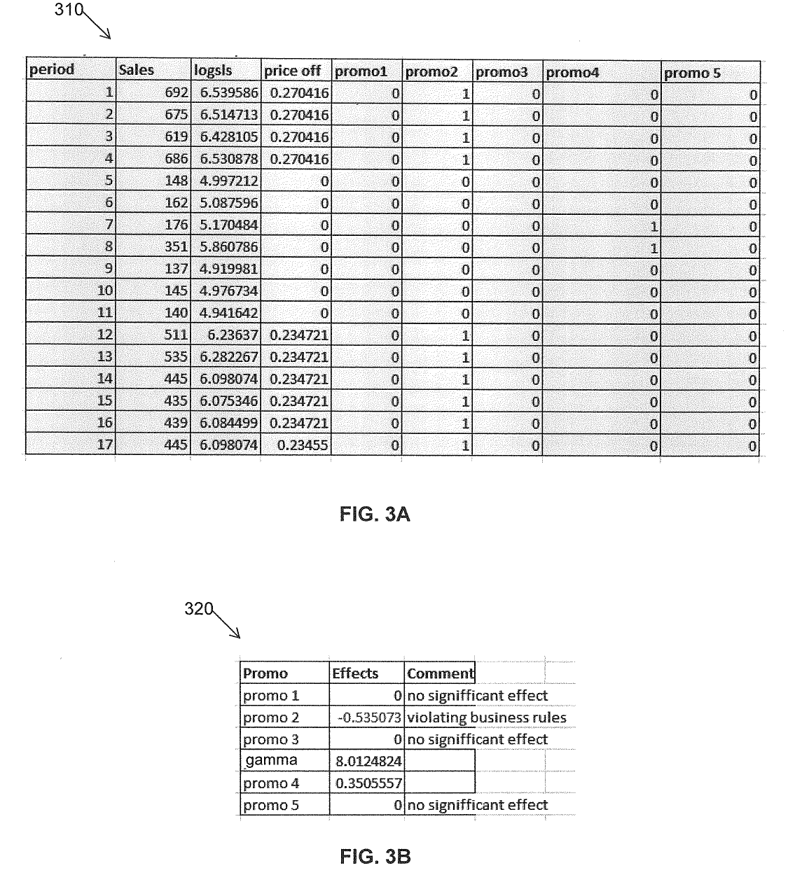

For example, in accordance with one embodiment, the regression logic 125 is configured to perform a first regression analysis jointly with respect to a plurality of promotion components associated with the item to generate first promotion effect values. If any of the first promotion effect values violate any rule of a set of defined business rules corresponding to the promotion effect values, then the phased operation is performed with respect to subsets of the plurality of promotion components to generate second promotion effect values. In this manner, more accurate and reliable promotion effect values may be generated. Performing such regression analyses on historical performance data with respect to a forecast demand model is discussed herein with respect to the example of FIG. 3A to FIG. 5.

In one embodiment, the comparator logic 130 is configured to compare promotion effect values generated by the regression logic 125 to corresponding rules of a set of defined business rules. As used in this context, the term “corresponding” means that a value of a particular promotion effect is used to make a comparison to a particular rule, or to a particular set of rules, of a plurality of rules, not necessarily to all of the plurality of rules. However, more than one promotion effect may correspond to and be compared to a same rule or a same set of rules. By performing such comparisons, the comparator logic 130 is configured to determine if one or more of the corresponding rules is violated by one or more of the promotion effect values. With respect to the example discussed above herein, the comparator logic 130 may be configured to compare the first promotion effect values to first corresponding rules and control the regression logic 125 accordingly. Furthermore, the comparator logic 130 may be configured to compare the second promotion effect values to the same first corresponding rules or to second corresponding rules. Performing such comparisons is discussed herein with respect to the example of FIG. 3A to FIG. 5.

Promotion effect values that pass (i.e., do not violate) the corresponding rules may be output to a data structure by the comparator logic 130 as final promotion effect values. The final promotion effect values may be used by a demand forecast model (e.g., the same demand forecast model used by the regression analyses) to predict future demand for an item based on one or more types of promotion (i.e., one or more active promotion components) for the item.

In accordance with one embodiment, the comparator logic 130 is configured to determine if a phased operation is to be performed by the regression logic 125. The determination is made based at least in part on the comparator logic 130 comparing the first promotion effect values (generated by jointly analyzing the full plurality of promotion components) to the corresponding rules. The comparator logic 130 may control the regression logic 125 by setting a flag or sending a signal to the regression logic 125 indicating to the regression logic 125 to perform the phased operation.

In one embodiment, the rules logic 135 is configured to store the rules (e.g., the business rules) in at least one data structure that is accessible by the comparator logic 130. Also, the rules logic 135 may be configured to operably interact with the visual user interface logic 120 via the graphical user interface to facilitate generation of the rules. For example, in one embodiment, a user may interact with the graphical user interface provided by the visual user interface logic 120 to generate or modify the rules in cooperation with the rules logic 135. Once the rules are settled upon, the rules may be stored by the rules logic 135 (e.g., in a memory of the computer system 100). Such rules are discussed herein with respect to the example of FIG. 3A to FIG. 5.

In accordance with one embodiment, a first set of rules may be defined which are to be compared to the first promotion effect values that are generated by an initial regression analysis in a first pass (i.e., considering the plurality of promotion components for an item jointly). Furthermore, a second set of rules may be defined which are to be compared to the second promotion effect values that are generated by two or more regression analyses in a phased operation (i.e., considering subsets of the plurality of promotion parameters in phases). In accordance with an alternative embodiment, both the first promotion effect values and the second promotion effect values may be compared to the same set of rules.

In one embodiment, any particular promotion effect may correspond to a particular rule. For example, a price elasticity promotion effect may correspond to a price elasticity rule. Therefore, a price elasticity promotion effect value generated by a regression analysis may be compared to the price elasticity rule by the comparator logic 130. Similarly, an email promotion effect may correspond to an email rule. Therefore, an email promotion effect value generated by a regression analysis may be compared to the email rule by the comparator logic 130.

In another embodiment, multiple promotion effects may correspond to a same single rule. For example, an email promotion effect value, a TV ad promotion effect value, and a newspaper promotion effect value may all correspond to a same rule that requires the promotion effect values to be positive (i.e., greater than a value of zero) to not violate the rule.

Furthermore, in one embodiment, the rules logic 135 is configured to determine the subsets of promotion components to be analyzed during the various phases (e.g., at least two phases) of the phased operation. For example, a first phase may perform a regression analysis with respect to a first subset having only a price discount component. A second phase may perform a regression analysis with respect to a second subset having a television advertisement component, an internet advertisement component, and an in-store advertisement component.

In one embodiment, determination of the subsets of promotion components for the phased operation may be accomplished by the rules logic 135 operably interacting with the visual user interface logic 120 via the graphical user interface. For example, in one embodiment, a user may interact with the graphical user interface provided by the visual user interface logic 120 to generate or modify the subsets in cooperation with the rules logic 135. In another embodiment, the subsets of promotion components for the phased operation may be determined automatically by the rules logic 135 based at least in part on results (e.g., first promotion effect values) of an initial regression analysis performed jointly on the plurality of promotion components.

In this manner, the promotion effects tool 110 is configured to generate promotion effect values that are reliable and accurate. Any instabilities, insignificant effects, or gross inaccuracies are determined, taken into account, and compensated (e.g., corrected) by the promotion effects tool 110.

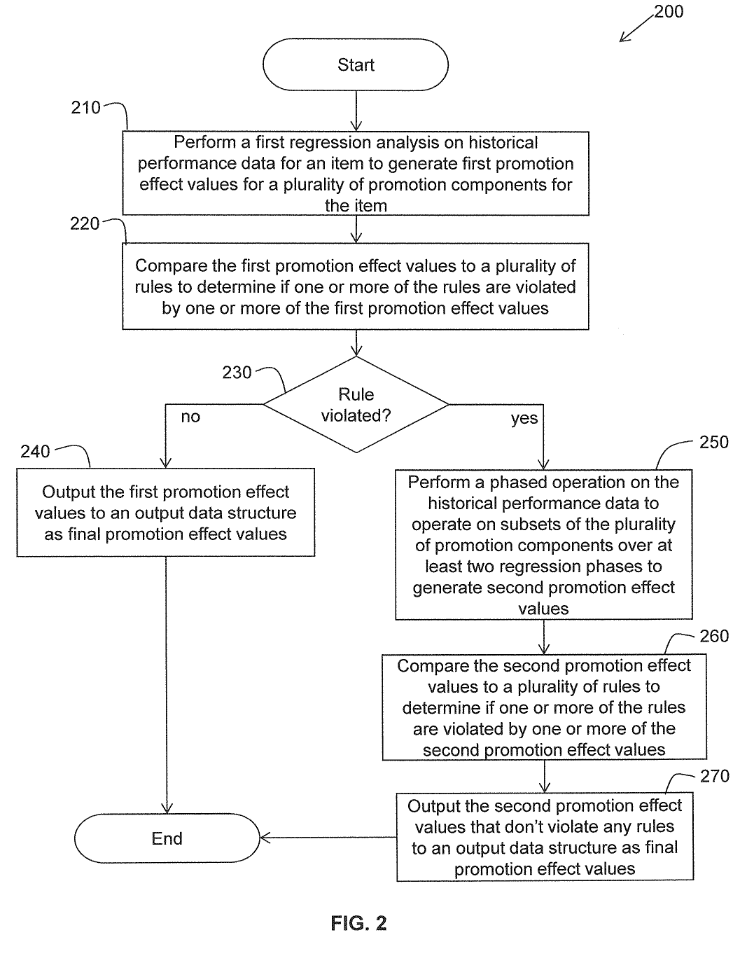

FIG. 2 illustrates one embodiment of a computer-implemented method 200, which can be performed by the promotion effects tool 110 of the computer system 100 of FIG. 1, for generating promotion effect values. Method 200 describes operations of the promotion effects tool 110 and is implemented to be performed by the promotion effects tool 110 of FIG. 1, or by a computing device configured with an algorithm of the method 200. For example, in one embodiment, method 200 is implemented by a computing device configured to execute a computer application. The computer application is configured to process data in electronic form and includes stored executable instructions that perform the functions of method 200.

Method 200 will be described from the perspective that, for an item (e.g., a retail item) sold at a location (e.g., a retail location), the item may be promoted in various ways at various times (retail periods). A retail calendar has many retail periods (e.g., weeks) that are organized in a particular manner (e.g., four (4) thirteen (13) week quarters) over a typical calendar year. A retail period may occur in the past or in the future. Historical performance data may include, for example, a number of units of an item sold in each of a plurality of past retail periods as well as associated promotion data.

Historical performance data includes sales and promotion information that has been recorded for an item that has been sold in past retail periods (e.g., over 52 weeks of the past year). Historical performance data may be stored in the database device 150, for example. In accordance with one embodiment, the promotion effects tool 110 is configured to read historical performance data for an item from at least one data structure (e.g., from data structures in the database 150).

The plurality of promotion components may include, for example, a price discount component and at least a television advertisement component, a radio advertisement component, a newspaper advertisement component, an internet advertisement component, an email advertisement component, or an in-store advertisement component, or combinations of these components. Data associated with the plurality of promotion components may include, for example, price discount data and Boolean data.

The price discount data may be numerical values that represent a fraction or percentage of a decrease in the price of the item (e.g., 0.270416 or 27.0416%). Boolean data may be numerical values of “0” and “1”, for example, indicating that individual promotion components of the plurality of promotion components were either active or inactive for a corresponding time period (i.e., either the item was promoted in accordance with a particular promotion component during a particular time period or it was not).

FIG. 3A illustrates an embodiment of a portion of a table 310 of historical performance data of an item. The table 310 includes unit sales data (the “sales” column of the table 310), data associated with a price discount component (the “price off” column of the table 310), and data associated with a plurality of five (5) other promotion components (the “promo1”, “promo2”, “promo3”, “promo4”, and “promo5” columns of the table 310).

For example, “promo1” may correspond to a television advertisement component, “promo2” may correspond to a newspaper advertisement component, “promo3” may correspond to an email advertisement component, “promo4” may correspond to an internet advertisement component, and “promo5” may correspond to an in-store advertisement component (e.g., a flyer or poster). The “period” column shows just seventeen (17) time periods for convenience.

However, the full table 310 actually has many more time periods of data over which regression analyses are performed.

Upon initiating method 200, at block 210, a first regression analysis is performed on historical performance data for an item to generate first promotion effect values for a plurality of promotion components associated with the item. The historical performance data includes at least unit sales data and data associated with the plurality of promotion components across a plurality of time periods (e.g., weekly retail periods). In accordance with one embodiment, the first regression analysis is performed by the regression logic 125 of the promotion effects tool 110.

The first regression analysis is based on a demand forecast model for the item. In one embodiment, the first promotion effect values for the item may be generated by the first regression analysis in accordance with a demand forecast model or algorithm, where at least a portion of the algorithm is represented by the following expression:

sales(i,l,t)=base(,l,t)*e^{gamma(i,l)price}^{_}^{off(i,l,t)}*Π(p(i,l,k)*o(i,l,t,k)+1)

where

sales(i,l,t) is the demand of the product i at location l for the period t.

base(i,l,t) is the base demand of the product i at location l for the period t.

gamma(i,l) is the price elasticity of product i at location l

price_off(i,l,t) is the price discount value of product i at location l for the period t.

p(ij,k) is the promotion effect of promo k for the product i at location l.

o(i,l,t,k) is a Boolean indicator having a value of “1” if the promotion k is active for product i at location l for period t, otherwise the value is “0”.

In accordance with one embodiment, the above expression for the demand forecast model/algorithm may be put into the following linear form such that the first regression analysis may be performed as a linear regression analysis:

$$log ( sales ) = {β}_{0} + gamma * price\_off + {\sum }_{j ∈ K} ( 1 + {β}_{j} )$$

where exp(β₀) is the baseline demand, gamma is the price elasticity, and exp(βⱼ) is the promotion effect of promotion j. In one embodiment, the first regression analysis is performed jointly across all of the promotion components (i.e., price discount, promo1, promo2, promo3, promo4, and promo5).

FIG. 3B illustrates an embodiment of a table 320 of first promotion effect values derived from the historical performance data of FIG. 3A by performing the first regression analysis at block 210. Referring to FIG. 3B, the resultant first promotion effect value corresponding to the price discount component is a price elasticity value, gamma, having a numerical value of 8.0124824. The resultant first promotion effect values, βⱼ, for the remaining promotion components (promo1, promo2, promo3, promo4, and promo5) are, respectively, 0, −0.535073, 0, 0.350557, and 0.

Referring to FIG. 2, at block 220, the first promotion effect values, gamma and βⱼ, are compared to corresponding rules to determine if one or more of the rules are violated by one or more of the first promotion effect values. In accordance with one embodiment, the rules are stored in the rules logic 135 and the comparison is performed by the comparator logic 130 of the promotion effects tool 110.

For example, in the current example of FIG. 3A to FIG. 5, the following rules apply:

Rule 1: The price elasticity value, gamma, is to be greater than zero (gamma>0) to enforce that a decrease in the price of the item results in an increase in sales of the item.

Rule 2: The promotion effect value, βⱼ, is to be greater than zero (βⱼ>0) indicating that an active promotion triggers higher sales of the item.

Rule 3: The exp(βⱼ) value is less than the ratio of the maximum number of units sold to the minimum number of units sold (exp(βⱼ)<max(sales)/min(sales)) to ensure that a calculated promotion effect is less than the maximum effect experienced in the historical performance data.

When a promotion effect value is negative (e.g., −0.535073 as for promo2 in FIG. 3B), the second business rule (Rule 2) is clearly violated. When the promotion effect value is zero (0), the effect of that promotion component is considered to be insignificant.

At block 230, if none of the business rules are violated, then method 200 proceeds to block 240 where the first promotion effect values are output to a data structure as final promotion effect values. The final promotion effect values may be plugged into the demand forecast model, as given above, to estimate future sales (demand) for the item.

However, in the current example, since at least one of the business rules (e.g., Rule 2) was violated as determined by the comparison, the method proceeds from block 230 to block 250. At block 250, a phased operation is performed on the historical performance data. The phased operation operates on subsets of the plurality of promotion components of the historical performance data over at least two regression analysis phases to generate second promotion effect values.

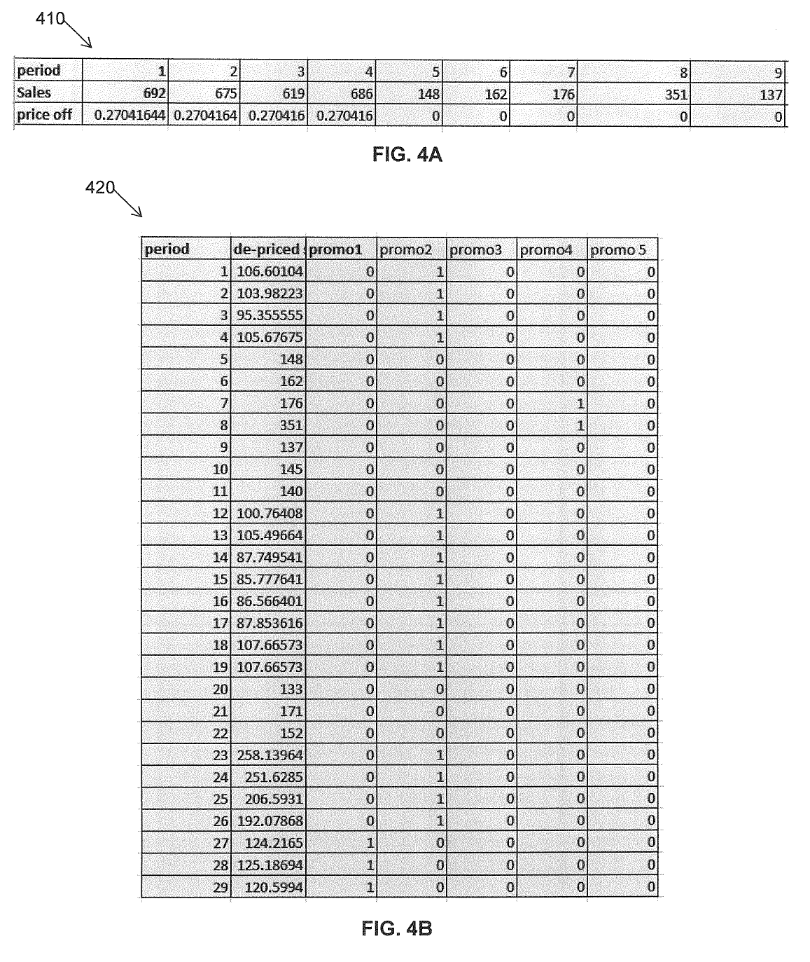

In accordance with one embodiment, performing the phased operation on the historical performance data includes performing a second regression analysis on a first subset (see FIG. 4A) of the plurality of promotion components to generate a price elasticity value (gamma) of the second promotion effect values. That is, the first subset of the plurality of promotion components represents price discounting. Therefore, the second regression analysis is performed with respect to the price discounting component (i.e., the exponential part of the demand forecast model), not the other components (promo1, promo2, promo3, promo4, promo5).

FIG. 4A illustrates an embodiment of a table 410 of price discount (price off) data extracted from the historical performance data of FIG. 3A and used in the second regression analysis of the phased operation. Again, for convenience, data is shown for a limited number of time periods in FIG. 4A. However, the regression analysis is performed over many more time periods. The resultant price elasticity value (gamma) from the second regression analysis is 6.9170, which is greater than zero (i.e., passed Rule 1) and is less than the initial price elasticity value of 8.0124824 from the first regression analysis that jointly considered all of the promotion components. The smaller value (6.9170) of gamma indicates that the effect of price discounting was over-estimated in the first regression analysis at least due to the negative value of promo2. In this manner, the effects of only price discounting is determined.

Furthermore, performing the phased operation on the historical performance data also includes removing the price discount effects from the historical performance data, based at least in part on the price elasticity value (6.9170) to form de-priced performance data. FIG. 4B illustrates an embodiment of a table 420 of de-priced performance data derived from the historical performance data of FIG. 3A and the promotion discount data of FIG. 4A. Again, data is shown for a limited number of time periods in FIG. 4B, for convenience.

As seen in table 420 of FIG. 4B, the de-priced column represents the unit number of sales of the item due to baseline sales of the item and any or all of the promotion components (promo1, promo2, promo3, promo4, promo5), but not due to price discounting. The effects of price discounting have been removed. For example, for period 1, the de-priced number of sales units is 106.60104 units, down from the total sales for period 1 of 692 units. The value of 106.60101 is generated using the price elasticity value, gamma, of 6.9170 in accordance with an algorithm represented by the following expression:

de-priced value=total sales/exp(price_off×gamma),

or, for the current example for period 1:

106.60104=692/(exp(0.270416×6.9170)

In this manner, the effects of a second subset of promotion components, including only the five (5) promotion components (promo1, promo2, promo3, promo4, promo5), may be determined. As such, performing the phased operation on the historical performance data includes performing a third regression analysis on the second subset (see FIG. 4B) of the plurality of promotion components to generate the remaining promotion effect values of the second promotion effect values.

At block 260, the second promotion effect values are compared to the corresponding rules (e.g., Rules 1 to 3 above, or to a different set of rules) to determine if one or more of the rules are violated by one or more of the second promotion effect values. In accordance with the current example, the second promotion effect values include a price elasticity value (gamma) and values for each of the remaining promotion components (promo1, promo2, promo3, promo4, promo5).

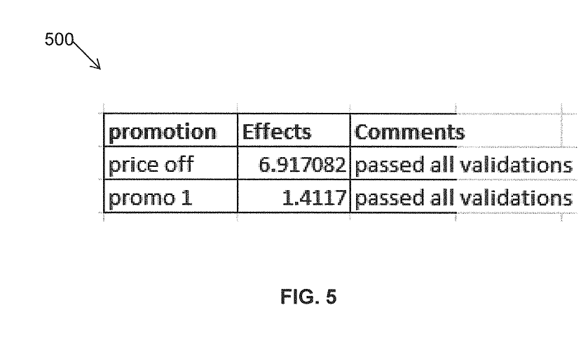

For the current example, only the value of gamma (6.917082) from the second regression analysis and the value for promo1 (1.4117) from the third regression analysis passed (i.e., did not violate) the corresponding business rules and were significant. FIG. 5 illustrates an embodiment of a table 500 of second promotion effect values derived from the promotion discount data of FIG. 4A and the de-priced performance data of FIG. 4B. In this manner, it may be determined which promotion components are effective for the item at the location where the item is sold.

In the current example of FIG. 3A to FIG. 5, the price discount promotion component and the “promo1” promotion component are the only promotion components having a legitimate and significant effect on the sales of the item, in accordance with the analysis of the historical performance data. At block 270 of method 200, the second promotion effect values (e.g., 6.917082 and 1.4117 in the current example), that do not violate any of the business rules, are output to a data structure as final promotion effect values for the item.

In this manner, a demand forecast model can use the final promotion effect values to predict future demand for the item. Order quantities may be adjusted, based on the predicted future demand for the item, to improve sales and reduce inventory costs. A reduction in inventory cost of as little as 1% can amount to millions of dollars in savings per year for some retailers. Furthermore, a retailer can more accurately manage inventory of merchandise by accounting for the effects of the individual promotion components or an inaccurate demand forecast for the merchandise.

Systems, methods, and other embodiments have been described that are configured to generate promotion effects for use by a demand forecast model. In one embodiment, a first regression analysis is performed on historical performance data for an item to generate first promotion effect values for a plurality of promotion components. The first promotion effect values are compared to a plurality of rules. If none of the rules are violated by the first promotion effect values, the first promotion effect values are output as final promotion effect values. If at least one of the rules is violated by the first promotion effect values, a phased operation is performed on the historical performance data. The phased operation operates on subsets of the promotion components of the historical performance data over at least two regression analysis phases to generate second promotion effect values. The second promotion effect values may be compared to the same rules (or to different rules). If none of the rules are violated, the second promotion effect values may be output as final promotion effect values.

### Computing Device Embodiment

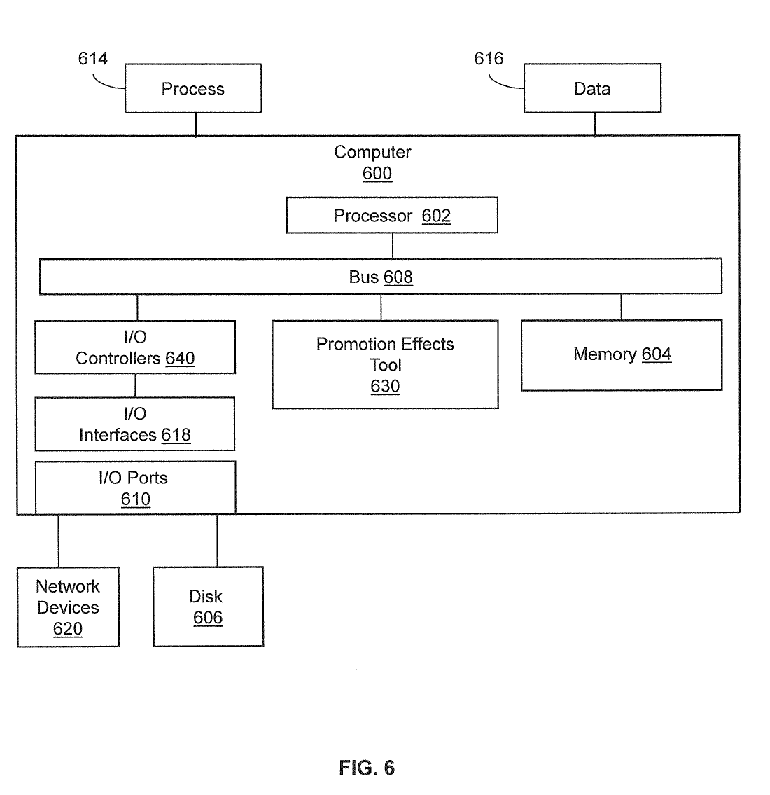

FIG. 6 illustrates an example computing device that is configured and/or programmed with one or more of the example systems and methods described herein, and/or equivalents. FIG. 6 illustrates one example embodiment of a computing device upon which an embodiment of a promotion effects tool may be implemented. The example computing device may be a computer 600 that includes a processor 602, a memory 604, and input/output ports 610 operably connected by a bus 608.

In one example, the computer 600 may include promotion effects tool 630 (corresponding to promotion effects tool 110 from FIG. 1) configured with a programmed algorithm as disclosed herein to analyze historical performance data for an item and generate promotion effect values that characterize the effects of various promotion types associated with the item. In different examples, the tool 630 may be implemented in hardware, a non-transitory computer-readable medium with stored instructions, firmware, and/or combinations thereof. While the tool 630 is illustrated as a hardware component attached to the bus 608, it is to be appreciated that in other embodiments, the tool 630 could be implemented in the processor 602, a module stored in memory 604, or a module stored in disk 606.

In one embodiment, tool 630 or the computer 600 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the generation of promotion effect values for an item. The means may also be implemented as stored computer executable instructions that are presented to computer 600 as data 616 that are temporarily stored in memory 604 and then executed by processor 602.

Tool 630 may also provide means (e.g., hardware, non-transitory computer-readable medium that stores executable instructions, firmware) for facilitating the generation of promotion effect values for an item.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM, PROM, and so on. Volatile memory may include, for example, RAM, SRAM, DRAM, and so on.

A storage disk 606 may be operably connected to the computer 600 via, for example, an input/output interface (e.g., card, device) 618 and an input/output port 610. The disk 606 may be, for example, a magnetic disk drive, a solid state disk drive, a floppy disk drive, a tape drive, a Zip drive, a flash memory card, a memory stick, and so on. Furthermore, the disk 606 may be a CD-ROM drive, a CD-R drive, a CD-RW drive, a DVD ROM, and so on. The memory 604 can store a process 614 and/or a data 616, for example. The disk 606 and/or the memory 604 can store an operating system that controls and allocates resources of the computer 600.

The computer 600 may interact with input/output devices via the i/o interfaces 618 and the input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, and USB ports.

The computer 600 can operate in a network environment and thus may be connected to the network devices 620 via the i/o interfaces 618, and/or the i/o ports 610. Through the network devices 620, the computer 600 may interact with a network. Through the network, the computer 600 may be logically connected to remote computers. Networks with which the computer 600 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

Oracle Matter No.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). An operable connection may include one entity generating data and storing the data in a memory, and another entity retrieving that data from the memory via, for example, instruction control. Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. §101.

“User”, as used herein, includes but is not limited to one or more persons, computers or other devices, or combinations of these.

“Operable interaction”, as used herein, refers to the logical or communicative cooperation between two or more logics via an operable connection to accomplish a function.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A method implemented by a computing device configured to execute a computer application, wherein the computer application is configured to process data in electronic form, the method comprising:
performing a first regression analysis on historical performance data for an item to generate first promotion effect values for a plurality of promotion components associated with the item, wherein the historical performance data includes at least unit sales data and data associated with the plurality of promotion components across a plurality of time periods;
comparing the first promotion effect values to a plurality of first rules to determine if one or more of the plurality of first rules is violated by one or more of the first promotion effect values;
if none of the plurality of first rules are violated, outputting the first promotion effect values to an output data structure as final promotion effect values; and
if at least one of the plurality of first rules is violated, performing a phased operation on the historical performance data, wherein the phased operation operates on subsets of the plurality of promotion components of the historical performance data over at least two regression analysis phases to generate second promotion effect values.

2. The method of claim 1, further comprising:
comparing the second promotion effect values to the plurality of first rules; and
outputting values of the second promotion effect values, that do not violate the plurality of first rules, to the output data structure as the final promotion effect values.

3. The method of claim 1, further comprising:
comparing the second promotion effect values to a plurality of second rules; and
outputting values of the second promotion effect values, that do not violate the a plurality of second rules, to the output data structure as the final promotion effect values.

4. The method of claim 1, wherein the data associated with the plurality of promotion components is obtained by reading, from a data structure, data that includes, for each time period of a plurality of time periods, a price discount value and a plurality of Boolean values indicating that individual promotion components of the plurality of promotion components were either active or inactive for a corresponding time period.

5. The method of claim 1, wherein generating the first promotion effect values includes generating at least one promotion effect value that is a price elasticity value representing a measure of how a demand for an item responds to a change in a price of the item.

6. The method of claim 1, wherein generating the second promotion effect values includes generating at least one promotion effect value that is a price elasticity value representing a measure of how a demand for an item responds to a change in a price of the item.

7. The method of claim 1, wherein the plurality of promotion components include a price discount component and at least a television advertisement component, a radio advertisement component, a newspaper advertisement component, an internet advertisement component, an email advertisement component, or an in-store advertisement component.

8. The method of claim 1, wherein the performing the phased operation on the historical performance data includes:
performing a second regression analysis on a first subset of the plurality of promotion components to generate a price elasticity value of the second promotion effect values, wherein the first subset of the plurality of promotion components represents price discounting;
generating de-priced performance data by removing price discount effects from the historical performance data based at least in part on the price elasticity value; and
performing a third regression analysis on a second subset of the plurality of promotion components, based at least in part on the de-priced performance data, to generate at least one remaining value of the second promotion effect values.

9. The method of claim 8, wherein the second subset of the plurality of promotion components includes at least one of a television advertisement component, a radio advertisement component, a newspaper advertisement component, an internet advertisement component, am email advertisement component, and an in-store advertisement component.

10. The method of claim 8, wherein the at least one remaining value includes at least one of a television advertisement value, a radio advertisement value, a newspaper advertisement value, an internet advertisement value, an email advertisement value, or an in-store advertisement value.

11. A computing system, comprising:
a regression module, including instructions stored in a non-transitory computer-readable medium, configured to:
(i) generate first promotion effect values for a plurality of promotion components associated with an item by performing a first regression analysis on historical performance data for the item, wherein the historical performance data includes at least unit sales data and data associated with the plurality of promotion components across a plurality of time periods, and
(ii) generate second promotion effect values by performing a phased operation on the historical performance data, wherein the phased operation operates on subsets of the plurality of promotion components of the historical performance data over at least two regression analysis phases; and
a comparator module, including instructions stored in the non-transitory computer-readable medium, configured to:
(i) compare the first promotion effect values to a plurality of rules to determine if one or more of the plurality of rules is violated by one or more of the first promotion effect values,
(ii) compare the second promotion effect values to the plurality of rules to determine if one or more of the plurality of rules is violated by one or more of the second promotion effect values, and
(iii) control the regression module to perform the phased operation when one or more of the plurality of rules is violated by one or more of the first promotion effect values.

12. The computing system of claim 11, further comprising a rules module, including instructions stored in the non-transitory computer-readable medium, configured to store the plurality of rules in at least one data structure, wherein the at least one data structure is accessible to the comparator module.

13. The computing system of claim 11, further comprising a database device configured to store at least the historical performance data.

14. The computing system of claim 11, further comprising a visual user interface module, including instructions stored in the non-transitory computer-readable medium, configured to:
provide a graphical user interface; and
facilitate inputting of the historical performance data for the item into the regression module.

15. The computing system of claim 14, further comprising a rules module, including instructions stored in the non-transitory computer-readable medium, configured to operably interact with the visual user interface module via the graphical user interface to facilitate generation of the plurality of rules.

16. The computing system of claim 14, further comprising a display screen configured to display and facilitate user interaction with at least the graphical user interface.

17. A non-transitory computer-readable medium storing computer-executable instructions that are part of an algorithm that, when executed by a computer, cause the computer to perform functions, wherein the instructions comprise instructions configured for:
performing a first regression analysis on historical performance data for an item to generate first promotion effect values for a plurality of promotion components associated with the item, wherein the historical performance data includes at least unit sales data and data associated with the plurality of promotion components across a plurality of time periods;
comparing the first promotion effect values to a plurality of first rules to determine if one or more of the plurality of first rules is violated by one or more of the first promotion effect values;
if none of the plurality of first rules are violated, outputting the first promotion effect values to an output data structure as final promotion effect values; and
if at least one of the plurality of first rules is violated, performing a phased operation on the historical performance data by operating on subsets of the plurality of promotion components of the historical performance data over at least two regression analysis phases to generate second promotion effect values as the final promotion effect values.

18. The non-transitory computer-readable medium of claim 17, wherein the instructions further include instructions configured for:
comparing the second promotion effect values to the plurality of first rules; and
outputting values of the second promotion effect values, that do not violate the plurality of first rules, to the output data structure as the final promotion effect values.

19. The non-transitory computer-readable medium of claim 17, wherein the instructions further include instructions configured for:
comparing the second promotion effect values to a plurality of second rules; and
outputting values of the second promotion effect values, that do not violate the plurality of second rules, to the output data structure as the final promotion effect values.

20. The non-transitory computer-readable medium of claim 17, wherein the instructions configured for performing the phased operation on the historical performance data include instructions configured for:
performing a second regression analysis on a first subset of the plurality of promotion components to generate a price elasticity value of the second promotion effect values, wherein the first subset of the plurality of promotion components represents price discounting;
generating de-priced performance data by removing price discount effects from the historical performance data based at least in part on the price elasticity value; and
performing a third regression analysis on a second subset of the plurality of promotion components, based at least in part on the de-priced performance data, to generate at least one remaining value of the second promotion effect values.
